(19) United States
(12) Patent Application Publication
(10) Pub. No.: US 2007/0089143 A1
(43) Pub. Date: Apr. 19, 2007

(54) Method and apparatus for providing dynamic display of content information associated with a device in a network

(76) Inventors: Chad Andrew LeFevre, Indianapolis, IN (US); Bret David Hawkins, Brownsburg, IN (US); James Duane Tenbarge, Fishers, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/578,819

(22) PCT Filed: Nov. 9, 2004
(86) PCT No.: PCT/US04/37348

§ 371 Date: May 9, 2006

Related U.S. Application Data
(60) Provisional application No. 60/518,902, filed on Nov. 10, 2003.

(51) Int. Cl. H04N 7/173; H04N 7/18; H04N 7/16

(52) U.S. Cl. 725/81; 725/80; 725/133; 725/141

(57) ABSTRACT

A television apparatus is operable to display table of content information from one or more peripheral devices interconnected to the television apparatus via a digital serial bus regardless of whether the television apparatus is currently tuned to the peripheral device. Particularly, table of content information is provided on a per peripheral device basis upon user request. The present invention allows the user to move through tracks of the displayed table of contents and play them, delete them, etc. The user will also be able to cycle through serial bus peripheral devices through the use of an input key on the remote, offering him easy access to multiple tables of contents, and giving the user an easy way to find a desired track. If the user has reached the last serial bus peripheral device in the serial bus list and attempts to input again, the display is wrapped back around to the first serial bus peripheral device. This is useful for allowing the user to start in the middle of the serial bus peripheral device list, as is the case when the user opens the menu when the television apparatus is already using the digital serial bus peripheral device as a current source input.

This U.S. non-provisional patent application claims the benefit of U.S. provisional patent application Ser. No. 60/518,902 filed Nov. 10, 2003 entitled “Method For Providing Dynamic Display of Content Information Associated With a Device In a Network”, the contents of which is incorporated herein by reference.

### BACKGROUND OF THE INVENTION

1. Field of the Invention

The present invention relates to a system for providing a display of content information on a display device, such as a television apparatus, associated with a peripheral device interconnected to the television apparatus via a digital data bus, such as an IEEE 1394 digital data bus.

2. Background Information

A data bus can be utilized for interconnecting electronic devices. With respect to consumer electronics devices, such as television receivers, display devices, direct broadcast satellite (DBS) receivers, cable television receivers (i.e. cable boxes), video-cassette recorders (VCRs), Audio/Video Hard Disk Drive devices (A/VHDDs), solid state memory devices (e.g., MP3 players), and the like, there is a trend toward providing the ability for these devices to be interconnected via such a data bus. Communication using a data bus occurs in accordance with a bus protocol. An example of a bus that may be used is the IEEE 1394 High Performance Serial Bus.

The IEEE 1394 bus protocol provides for communicating both control information and data. On an IEEE 1394 serial bus, control information is generally passed using the asynchronous services of the serial bus. Control information for a particular application can be defined using for example, Common Application Language (CAL) or AV/C. The incorporation of IEEE 1394 bus technology into current consumer electronics devices, such as those described above, allow the consumer electronics devices to be networked. Such a home network typically utilizes a display device, such as a television display, as a primary viewing and/or playback device for material stored in peripheral IEEE 1394 devices interconnected to the television apparatus.

Most interconnected 1394 devices store or have A/V content that is playable on the television apparatus. In order to view the contents stored on a peripheral device, it is generally necessary to use a control of the peripheral device to sequence through tracks of content. Known peripheral devices, however, only provide, and thus the television apparatus only shows, title data and track times for a current track. The user must manually switch tracks in order to see all of the title data and track times. Therefore, in order to ascertain content of a peripheral device, it is necessary for a user to manually switch through the entire content. Generally, one line of a television display menu shows the user rudimentary content data (i.e. only track title data) for a peripheral 1394 device, but only when the user presses a particular key on the remote and only when the television apparatus tuned to the 1394 device, that is, the device is selected as the video source. Currently, however, there is no manner of viewing content information on a television for an interconnected peripheral device when the television apparatus is not currently tuned to, or selected as the video source, the interconnected peripheral device.

It is thus evident from the above discussion that what is needed is a method and an apparatus for allowing a user to view content information on a television apparatus for an interconnected peripheral device regardless of what input the television apparatus is currently tuned.

It is thus also evident from the above discussion that what is needed is a method and an apparatus for allowing a user to view table of contents information for peripheral digital serial bus devices interconnected to a television apparatus via a digital serial bus.

It is thus further evident from the above discussion that what is needed is a method and an apparatus for allowing a user to browse a table of contents for each one of peripheral digital serial bus devices interconnected via a digital serial bus to a television.

These and other needs are met through application of the principles of the subject invention as embodied in one or more various forms and/or structures such as are shown and/or described herein.

### SUMMARY OF THE MENTION

In a digital serial bus network, the present invention allows a user to browse table of contents information on a television apparatus for any one or more peripheral devices interconnected to the television apparatus via the digital serial bus regardless of which input source the television apparatus is tuned.

In one form, the present invention provides a method for displaying on a television apparatus, content information associated with a peripheral device interconnected with the television apparatus via a digital serial bus. The method includes: (a) providing, by the television apparatus, an option allowing a user to request content information associated with a selected peripheral device interconnected to the television apparatus via the digital serial bus, wherein the option is provided by the television apparatus regardless of whether the selected peripheral device is a currently selected input source for the television apparatus; (b) obtaining by the television apparatus, content information from the selected peripheral device; and (c) displaying by the television apparatus, the received content information for the selected peripheral device.

In another form, the present invention provides a digital television apparatus. The digital television apparatus includes: (a) means for providing an option allowing a user to request viewing of content information associated with a selected peripheral device interconnected to the digital television apparatus via a digital serial bus, the option provided by the television apparatus regardless of whether the selected peripheral device is a currently selected input source for the digital television apparatus; (b) means for obtaining content information from the selected peripheral device; and (c) means for displaying the received content information for the selected peripheral device.

The present invention provides a television apparatus that is able to retrieve content information from the tables of contents on a disk or other storage medium, associated with the peripheral device and display this data on a per device. The present invention allows the user to browse the table of contents for the various peripheral devices even if the television is not currently tuned to the peripheral device when the menu option was provided, typically in response to user input. If, while looking at content data from one device, the user presses an input key on a remote, the present invention switches to the next peripheral device interconnected to the television apparatus and displays all of its content, such as all track data (e.g. artist, genre, date/time created, total time, current time if playing, and potentially a description that has been associated with the track). Information coming from PSIP data, if that data was recorded as an ATSC stream, is also displayable in the manner described herein for digital or MPEG2 data.

When the digital serial bus is IEEE 1394 compliant and the various peripheral devices are IEEE 1394 compliant, the present invention allows a user to view on the television apparatus, table of contents data for any 1394 compliant peripheral device interconnected to the television apparatus regardless of whether the television apparatus is currently tuned to any particular IEEE 1394 compliant peripheral device. The invention further allows the user to manipulate the various tracks of content for each peripheral IEEE 1394 device from the television apparatus. Such manipulation may include the ability to move through the listed tracks (audio, video, or audio/video programs or data), play the listed tracks, delete the listed tracks, and other functionality for controlling the tracks.

The present invention also allows the user to cycle through the various interconnected 1394 devices through the use of a designated key on a remote control of the television apparatus. This offers the user easy access to multiple tables of contents, as well as giving the user an easy way to find a desired track. Moreover, if a user has reached the last 1394 peripheral device in the 1394 list of peripheral devices (i.e. the 1394 peripherals/peripheral devices interconnected to the television apparatus), the present invention provides for wrapping the user back to the table of contents for the first 1394 peripheral device upon further user input. This allows the user to start in a middle of a list of 1394 peripheral devices, as may be the case when the user opens the menu when already connected to a 1394 peripheral device. The invention may be implemented in the 1394 peripheral devices, for example, using programming techniques known to those skilled in the art.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 shows a simplified block diagram of an exemplary digital serial bus network in which the present invention may be embodied;

FIG. 2 shows a block diagram of the various components of the exemplary network of FIG. 1 operable to carry out the principles of the present invention;

FIG. 3 is a flowchart of an exemplary manner of operation of the present invention; and

FIG. 4 is a flowchart of another exemplary manner of operation of the present invention.

Corresponding reference characters indicate corresponding parts throughout the several views. Although the drawings represent embodiments of the invention, the drawings are not necessarily to scale and certain features may be exaggerated in order to better illustrate and explain the invention. The exemplifications set out herein illustrate various embodiments of the invention, but such exemplifications are not to be construed as limiting the scope of the invention in any manner.

### DESCRIPTION OF THE PREFERRED EMBODIMENT

The embodiment disclosed herein is not intended to be exhaustive or limit the invention to the precise form disclosed so that others skilled in the art may utilize its teaching.

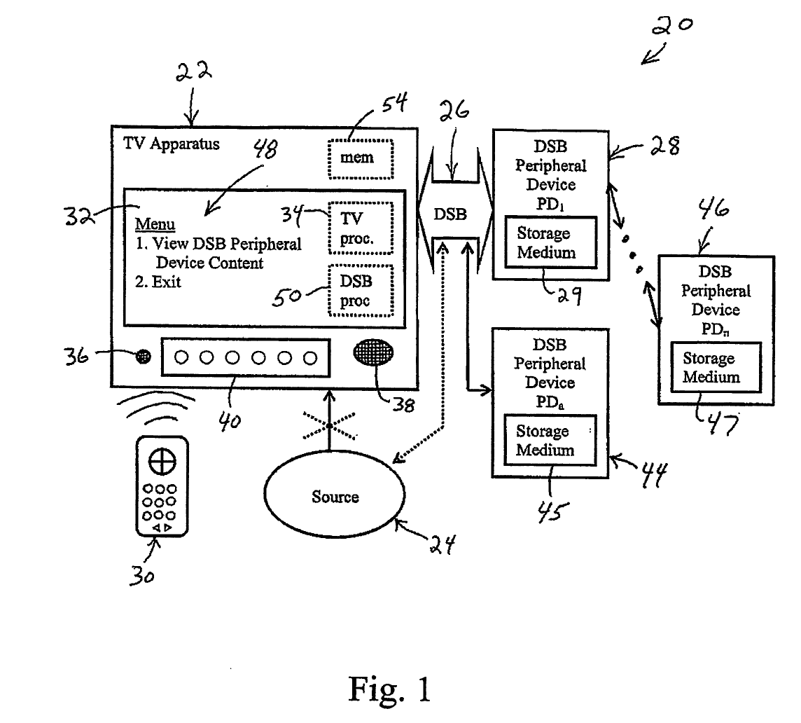

FIG. 1 illustrates an exemplary system or network 20 incorporating and/or operable according to the principles of the present invention. Being exemplary, the system 20 represents the many physical embodiments of a system or network operable in accordance with the principles of the present invention. In particular, the system or network 20 represents the various configurations achievable with digital serial bus components.

The system 20 of FIG. 1 includes a television apparatus 22 having basic functionality and/or features associated with a typical televisions/television apparatus as well as the present functionality/features described herein in accordance with the present principles. The television apparatus 22 is operable, configured and/or adapted to process digital television signals, digital audio/video (A/V) content and/or the like (collectively, digital content), as well as analog television signals and/or analog audio/video (A/V) content and/or the like (collectively, analog content) from various input sources available for the television 22.

In addition to processing and playing content, the television apparatus 22 is also configured, adapted and/or operable to display on screen displays including text, graphics, pictures or the like. The television apparatus 22 also accepts user input for controlling the television apparatus 22, accessing various interactive and/or non-interactive menus for user selection of menu choices, television defaults, and/or the like such as are known in the art and those described herein in accordance with the principles of the present invention. In accordance with the principles of the present invention, the television apparatus 22 is further operable to display one or more menus, that include user selectable options in response to user input and/or television system signals, and accept user input for user selection of user choices/options.

The television apparatus 22 is thus representative of various embodiments of a television signal receiver of the type having a display 32 and television signal processing and feature/function control unit 34 for functioning in the above-described manner(s) and those described below. The television apparatus 22 accepts user input via a remote control 30 that transmits remote control signals or input to a remote control receiver 36. The remote/remote receiver 30/36 may utilize IR, RF or other transmission means. The remote control 30 is used to provide user input signals with respect to menu options or choices, such as, but not limited to, channel change inputs, volume control inputs, transport command inputs, settings inputs, or the like.

The television apparatus 22 includes a speaker 38 or speakers for playing audio. Additionally, the television apparatus 22 may have front panel user controls 40. While only one source 24 for television signals is shown, the television apparatus 22 preferably has a plurality of various types of television signal input sources. The source 24 thus represents the various television signal source inputs such as satellite, terrestrial (over-the-air), cable and the like.

Moreover, the system 20 includes a digital serial bus (DSB) 26 that interconnects the television apparatus 22 with a DSB (compliant) peripheral device (PD₁) 28. The digital serial bus 26 may be any appropriate type of digital serial bus, but is preferably the IEEE 1394 High Performance Serial Bus. Therefore, while the present invention is discussed hereinafter with respect to an IEEE 1394 digital bus, various types of digital serial buses may be used and it is to be understood that the invention is not limited to such a bus. The television apparatus 22 thus includes digital serial bus (DSB) processing and ports 50 for connection with DSB compliant peripheral devices.

The peripheral device 28 has a storage medium 29 such as solid state memory, a hard drive, or the like. The storage medium 29 includes program content stored thereon. The content may be digital audio, digital video and/or digital audio/video programs that can be transmitted over the digital serial bus. As such each peripheral device 28 includes digital serial bus hardware/firmware/software in order to function as a digital serial bus compliant peripheral device.

A plurality of peripheral devices (PD₁ through PDₙ) is shown daisy-chained to one another as is possible with the IEEE 1394 bus. Each additional peripheral device 28 may also include a storage medium. Additionally, another peripheral device (PDₐ) 44 having a storage medium 45 is shown connected to the television apparatus 22 via another DSB port rather than being daisy-chained. The television apparatus 22 is operable to obtain content information for all of the daisy-chained peripheral devices (PD₁ through PDₙ) as well as any others (e.g. PDₐ).

The source 24 may be a non-DSB device in which case it is connected to the television apparatus 22 via a typical television signal input terminal. In the case that the source 24 is another DSB device, it may be connected to the serial bus 26 as represented by the dashed arrow between the source 24 and the DSB 26.

Moreover, various aspects of the 1394 serial bus are not discussed herein but are explained more fully in U.S. Pat. No. 6,665,020, issued to Stahl et al. on Dec. 16, 2003, which is incorporated herein by reference. Both U.S. Pat. No. 6,665,020 and the present invention are commonly assigned.

The television apparatus 22 in response to a user input via the remote control 30, front control panel 40, initiated by the television apparatus or otherwise (via another device connected to the television apparatus) to provide an on-screen menu (see menu 48 on display 32 of television apparatus 22) in response to user request to view content information of a DSB peripheral device. Particularly, the present invention allows a user to browse content information (e.g. table of contents information) on the television apparatus 22 for any one or more of the peripheral devices (PD₁ through PDₙ) interconnected to the television apparatus 22 via the DSB 26 regardless of which input source the television apparatus is tuned.

The television apparatus 22 retrieves content data associated with the programs (e.g. track data, title data, artist, genre, time/date created, total time, etc.) from the tables of contents data on the disk or other storage medium associated with the peripheral device, and displays this data on a per device basis on the television apparatus 22. The television apparatus 22 also allows the user to browse the table of contents for the various peripheral devices even if the television apparatus is not tuned to the particular peripheral device when the menu option was provided, typically in response to user input. If, while looking at content data from one device, the user presses an input key on a remote 30, the television apparatus 22 switches to the next peripheral device interconnected to the television apparatus 22 and displays all of its content data. Information coming from PSIP data, if that data was recorded as an ATSC stream, is also displayable in the manner described herein for digital or MPEG2 data.

The television apparatus 22 also allows the user to cycle through the various interconnected peripheral devices through the use of a designated key on the remote control 30. This offers the user easy access to multiple tables of contents, as well as giving the user an easy way to find a desired track of a specific peripheral device. Moreover, if a user has reached the last peripheral device in the list of peripheral devices, the present invention provides for wrapping the user back to the table of contents for the first peripheral device upon further user input. This allows the user to start in a middle of the list of peripheral devices, as is the case when the user opens the menu when already connected to a particular peripheral device. The teachings according to this invention may be implemented in the peripheral devices, for example, using programming techniques known to those skilled in the art.

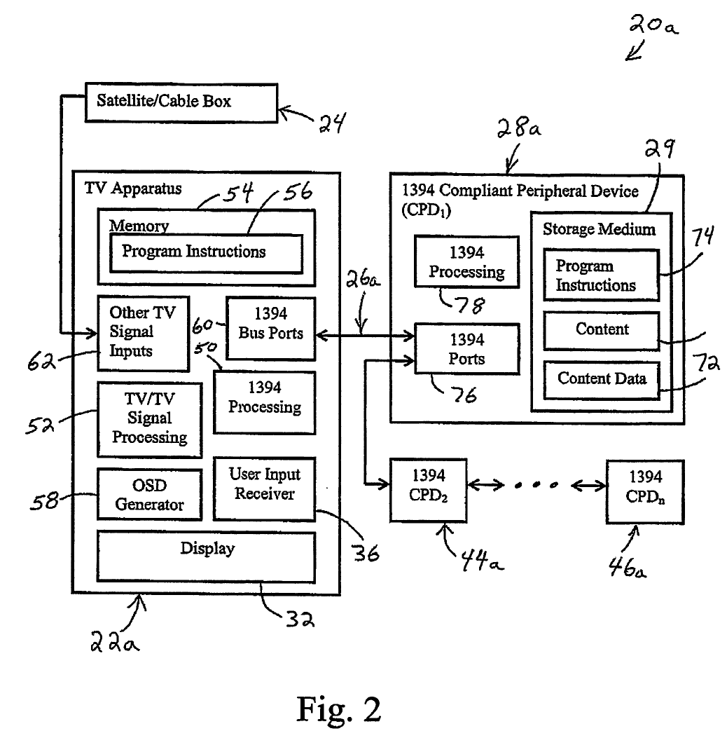

Referring to FIG. 2, a more detailed block diagram of an exemplary network 20a is depicted that is similar to the network 20, but which is specifically configured for the IEEE 1394 digital serial bus protocol/standard. The network 20a includes a television apparatus 22a, a satellite or cable box 24 as a source input (62) for providing television signals. The television apparatus 22a includes 1394 bus ports 60 for connection of 1394 compliant peripheral devices (CPD) 28a (1394 CPD₁) and 44a (1394 CPD₂) through 46a (1394 CPDₙ). Moreover, the television apparatus 22a is shown including memory 54 for storing program instructions 56 for the operation of the television 22a and its features/functions. Moreover, the television apparatus 20 includes an on-screen display generator 58 operable, configured and/or adapted to provide the on-screen menus and/or text and/or graphics to be shown on the display 32.

These components of the television apparatus 22a provide the means for processing television signals, A/V signals and the like, means for communicating with, storing and retrieving content and/or content data to and from the 1394 compliant peripheral devices.

The present invention allows a user to view on a IEEE 1394 compliant television apparatus, table of contents data for any 1394 compliant peripheral device interconnected via a IEEE 1394 network to the television apparatus regardless of whether the television apparatus is currently tuned to the particular IEEE 1394 compliant peripheral device, that is the particular peripheral device is selected for viewing. The invention further allows the user to manipulate the various tracks of content for each peripheral IEEE 1394 device from the television apparatus. Such manipulation may include the ability to move through the listed tracks (audio, video, or audio/video programs or data), play the listed tracks, delete the listed tracks, and other functionality for controlling the tracks.

The peripheral device 28a is particularly shown with 1394 ports 76 for connecting the device to the television apparatus or to another 1394 compliant peripheral device. The peripheral device 28a also includes 1394 processing interface 78 for communicating between, receiving from and sending to the television apparatus 22a, data (e.g. content and content data) and control data in accordance with the 1394 protocol. The storage medium 29 such as a hard drive, includes program instructions 74 for operation of the peripheral device as necessary, as well as content 70 (e.g. tracks of content) as well as content data 74 (e.g. table of contents, including all types of track data). The other peripheral devices 44a through 46a each include the appropriate components as described herein.

The television apparatus 22a is operable to obtain content data from one or more peripheral devices via the 1394 serial bus/protocol. The television apparatus 22a may be programmed to automatically request such information from the peripheral device, in addition to the self identification information, upon detection of the peripheral device, and/or startup of the television apparatus. Each peripheral device responds to the television apparatus 22a by transmitting its appropriate content data to the television apparatus. Thus, television apparatus obtains content descriptive information from the peripheral device even if the peripheral device has not been selected by the user. The television apparatus is operative to provide change in content data if manipulation provides changes to the content data.

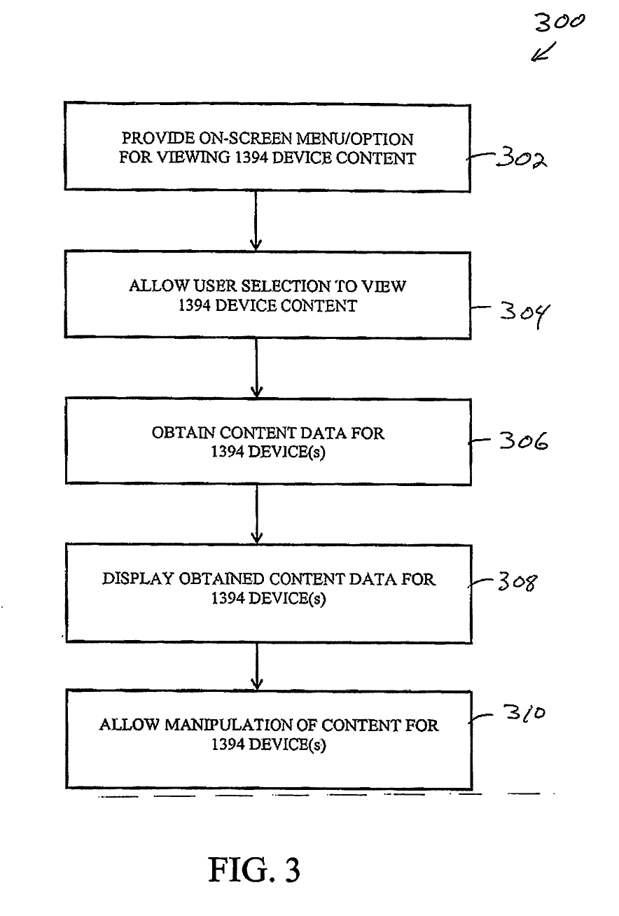

Referring to FIG. 3, there is depicted a flowchart, generally designated 300, of an exemplary method of operating the television apparatus 22 in accordance with the present principles. The method 300 is implemented by the television apparatus and responds to user input. Moreover, the flowchart of method 300 assumes that the digital serial bus is the IEEE 1394 serial bus, and the peripheral devices are IEEE 1394 compliant peripheral devices. Such assumption, however, is not to be construed as limiting the scope of the present invention.

In block 302, an on-screen menu/menu option is provided for allowing the user to view 1394 device content information/data (e.g. entire table of contents and supporting data). The menu/option may be a specialized menu or a general menu with a 1394 device viewing mode option. In block 304, the menu/option allows the user to select to view 1394 device content from a specific peripheral device, as opposed to exiting the menu or making another menu selection. In block 306, the television apparatus obtains content data for one or more of the selected 1394 devices interconnected to the television apparatus via the 1394 bus. In one form, the television apparatus retrieves storage medium content data for all of the interconnected 1394 devices.

In block 308, the obtained content data for the 1394 device(s) is displayed on the television apparatus (or associated display) for browsing by the user. In the case that the television apparatus obtains content data from multiple 1394 devices, the content data is displayed on a per device basis, but may be provided in various alternative forms. Thereafter, in block 310, the television apparatus allows the manipulation of the content data.

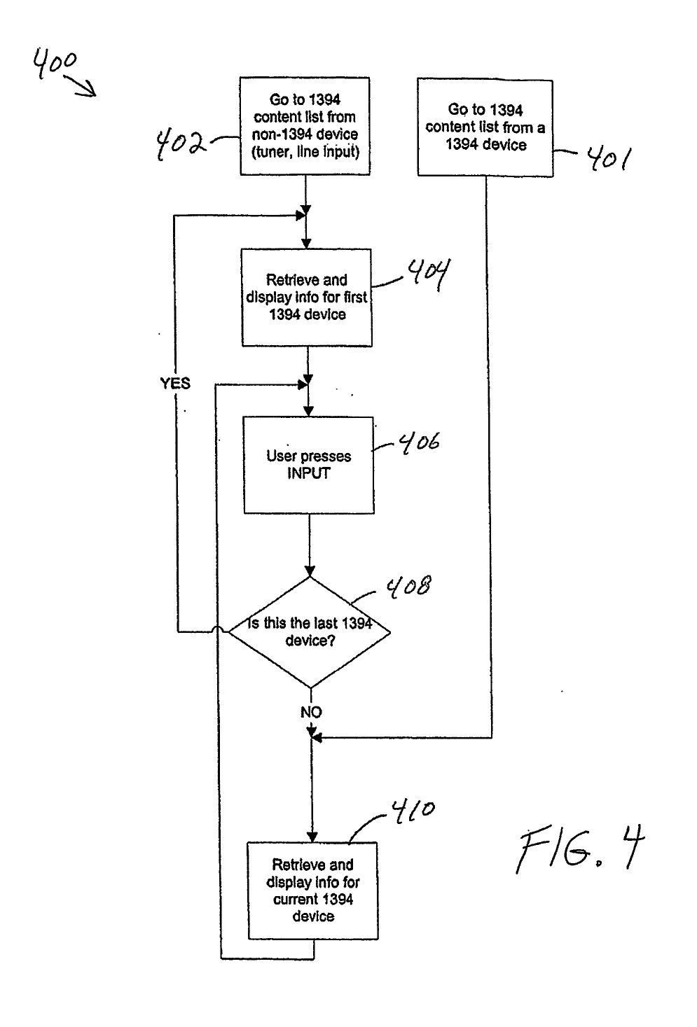

Referring to FIG. 4, there is depicted a flowchart, generally designated 400, of another exemplary method of operating television apparatus 22 in accordance with the present principles, particularly, of a method for displaying content information for one or more peripheral devices interconnected to the television apparatus via a digital serial bus. The flowchart 400 assumes that the digital serial bus is the IEEE 1394 serial bus, and the digital serial bus peripheral devices is an IEEE 1394 peripheral devices. Such assumption, however, is not to be construed as limiting the application of the present invention.

Upon a user command to view content information for a selected 1394 compliant device, the television apparatus 22 determines whether the source input of the television apparatus is set to a 1394 device. It should be appreciated that the present invention allows a user to view content data for a 1394 compliant device even if the 1394 compliant device is not the selected television apparatus source input, that is, the selected peripheral device is not the device currently being viewed on the television apparatus. The remote control 30 of the television apparatus 22 may, for example, include an INPUT button or key that allows the user to switch to the various television signal/content sources that are connected to the television apparatus, including the television tuner, one or more LINE INs, or one or more 1394 compliant devices. By pressing the INPUT button the user may cycle through the various source inputs to select a source input to watch on the television apparatus. The user, however, may view the contents of a non-selected peripheral device by selecting the device using another designated key on the remote control or through on screen display selections.

The ability to allow a user to view content information or data for a 1394 compliant device that is connected to the television apparatus via the 1394 serial bus is preferably accomplished through an on-screen menu (e.g. menu 48 of FIG. 1). The on-screen menu is provided on the display 32 (see FIG. 1) through user actuation of a MENU button or key on the remote 30. Alternatively, the remote may have a dedicated button or key (separate from the INPUT button) for selecting a particular 1394 compliant device for content data viewing. Thereafter, the user may navigate through the displayed menu in a manner known in the art. In this manner, the user may bring up and browse or peruse content data for a 1394 compliant device even though the 1394 compliant device is not the selected source input (i.e. the user is watching another source input). This may be accomplished by a separate remote button or menu selection.

In block 402, the television apparatus has been determined to be “tuned” (source input selected) to a non-1394 device (e.g. the television source input is the television tuner or a line input of the television). Thus, in block 402 the television initiates communication to a first 1394 device in the 1394 bus list of devices. In block 404, the television apparatus retrieves content information for the first 1394 device. Block 404 further provides for the display of the retrieved content information for the first 1394 device on the television apparatus. At this point, the user may manipulate the content information as described above.

In block 406, the television apparatus receives a further input from the user indicating that the user desires to see content information from another (or different) 1394 device. In block 408, the television apparatus determines whether the next 1394 device is the last 1394 device on the 1394 list. If the next 1394 device is the last 1394 device (i.e. YES and thus the first 1394 device is the only 1394 device interconnected to the television apparatus), then the television apparatus returns to block 404, and retrieves and displays the content information for the first 1394 device again.

If the next 1394 device is not the last 1394 device in the 1394 list (i.e. NO and thus there is at least one more 1394 device interconnected to the television apparatus), the television apparatus goes to block 410, and retrieves and displays content information for the next (now current) 1394 device. Thereafter, the television apparatus waits for another user input (block 406), or leaves the display of 1394 device content mode of the television apparatus and returns to other television operation.

If it is determined at the outset of the manner of operation 400 that the television apparatus is currently tuned to a 1394 device (i.e. the 1394 device is the selected source input), block 401, the television apparatus 22 proceeds to block 410 wherein content information for the current 1394 device (i.e. the one that the television is currently tuned to) is retrieved and displayed. Thereafter, the routine 400 waits for another user input (block 406), or leaves the display of 1394 device content mode of the television apparatus and returns to other television operation.

In this manner, the television apparatus is operable to obtain and display content information or data (e.g. table of content information/data) for any 1394 peripheral device interconnected to the television apparatus, regardless of whether the television apparatus is currently tuned to the 1394 device. Moreover, this manner allows the user to cycle through the various 1394 devices of the digital bus system or network. Also, the television apparatus may obtain the content information from all of the peripheral devices upon start up, or when connection of the peripheral device is detected.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and that fall within the limits of the appended claims.

1. A method for displaying on a television apparatus, content information associated with peripheral device interconnected with the television apparatus via a digital serial bus, the method comprising:
receiving, by the television apparatus, a user request to view content information associated with a selected peripheral device interconnected to the television apparatus via the digital serial bus;
obtaining, by the television apparatus, content information from the selected peripheral device regardless of whether the selected peripheral device is a currently selected input source for the television apparatus; and
displaying, by the television apparatus, the received content information for the selected peripheral device.

2. The method of claim 2, wherein the digital serial bus is an IEEE 1394 compliant serial bus.

3. The method of claim 3, further comprising:
in response to a second user input,
obtaining, by the television apparatus, content information from a second selected peripheral device; and
displaying, by the television apparatus, the received content information of the second selected peripheral device.

4. The method of claim 1, wherein the content information comprises table of contents information for programs stored on a storage medium of the selected peripheral device.

5. The method of claim 4, wherein the table of contents information is displayed on the television apparatus on a per peripheral device basis.

6. The method of claim 5, further comprising:
allowing by the television apparatus, a user to cycle through a loop of peripheral devices interconnected to the television apparatus.

7. The method of claim 6, further comprising:
allowing by the television apparatus, a user to manipulate the displayed content information in response to user input received by the television apparatus.

8. The method of claim 7, wherein manipulation includes moving through the content information, deleting the content information, and playing selected programs.

9. A method for displaying on a digital television apparatus, table of content information associated with a peripheral device interconnected with the television apparatus via an IEEE 1394 bus, the method comprising:
providing, on the digital television apparatus in response to a first user input to the digital television apparatus, a menu allowing a user to request viewing of table of content information of a selected peripheral device interconnected to the digital television apparatus via the IEEE 1394 bus, the option provided by the digital television apparatus regardless of whether the selected peripheral device is a currently selected input source for the digital television apparatus;
establishing, by the television apparatus, communication between the digital television apparatus and the selected peripheral device via the IEEE 1394 bus;
obtaining, by the digital television apparatus, table of contents information associated with a storage medium of the selected peripheral device; and
displaying, by the digital television apparatus, the received table of contents information for the selected peripheral device.

10. The method of claim 9, further comprising:
detecting connection of the selected peripheral device to the digital serial bus, and upon detection, obtaining the table of content information from the selected peripheral device.

11. The method of claim 9, further comprising:
in response to a second user input,
establishing communication between the digital television apparatus and a second selected peripheral device via the 1394 serial bus;
obtaining by the digital television apparatus, table of contents information associated with a storage medium of the second selected peripheral device; and
displaying by the digital television apparatus, the table of contents information from the second selected peripheral device.

12. The method of claim 9, wherein the table of contents information of the selected peripheral device includes one or more of title, time created, total track time, current track time, artist, genre, and program description for each track of table of contents data.

13. The method of claim 9, further comprising:
allowing by the digital television apparatus, a user to cycle through a loop of peripheral devices interconnected to the television apparatus via the 1394 serial bus.

14. The method of claim 9, further comprising:
allowing by the digital television apparatus, a user to manipulate the displayed content data in response to user input received by the digital television apparatus including moving through the table of contents information, deleting table of contents information, and playing a selected program.

15. A digital television apparatus comprising:
(a) means for receiving a user request to view content information associated with a selected peripheral device interconnected to the television apparatus via a digital serial bus;
(b) means for obtaining content information from the selected peripheral device regardless of whether the selected peripheral device is a currently selected input source for the television apparatus; and
(c) means for displaying the received table of content information for the requested digital serial bus compliant peripheral device.

16. The digital television apparatus of claim 15, further comprising:
(e) means for allowing a user to cycle through a loop of peripheral devices interconnected on the digital serial bus for viewing of table of content information associated with a selected one of the peripheral devices.

17. The digital television apparatus of claim 15, further comprising:
(f) means for allowing a user to manipulate the displayed table of content information in response to user input received by the digital television apparatus.

18. The digital television apparatus of claim 17, wherein manipulation includes moving through the table of content information, deleting table of content information, and playing a selected program.
